(19) United States
(12) Patent Application Publication
(10) Pub. No.: US 2020/0234221 A1
(43) Pub. Date: Jul. 23, 2020

(54) IMPLEMENTING INDIVIDUAL CUSTOMIZED TASK PRIORIZATION BASED ON REAL-TIME CONTEXT

(71) Applicant: International Business Machines Corporation, Armonk, NY (US)

(72) Inventors: Kai Liu, Malden, MA (US); Su Liu, Austin, TX (US); Manjunath Ravi, Austin, TX (US); Zhichao Li, Austin, TX (US)

(21) Appl. No.: 16/254,861

(22) Filed: Jan. 23, 2019

(51) Int. Cl. G06Q 10/06; G06F 7/08; G06N 20/00

(52) U.S. Cl. CPC G06Q 10/063114; G06N 20/00; G06Q 10/06314; G06F 7/08

(57) ABSTRACT

A method and computer system are provided for implementing individual customized task prioritization based on real-time context. A list of a plurality of tasks to be completed by a user based on a criteria is received. The list of a plurality of tasks is analyzed to determine ordering of the list of the plurality of tasks. A user's context is determined from user information received from predefined sensors, and prioritization of the plurality of tasks of the list is determined. The ordering of the plurality of tasks is identified by applying the current user's context and the criteria and the ordering identifies a current task to start.

### FIELD OF THE INVENTION

The present invention relates generally to the data processing field, and more particularly, relates to a method and computer system for implementing individual customized task prioritization based on real-time context.

### DESCRIPTION OF THE RELATED ART

People make a task or to-do list as reminder of tasks or activities they need to complete. Tasks are usually time sensitive and subject to being changed, rearranged, or rescheduled. This could be a list of errands they need to run in the next day, or short-term resolution in the next month, or business plan in a long term, for example, half a year to several years. A task or to-do list is not usually created and presented in either an organized, systematic, or sorted manner considering individual task features. A user does not benefit from resource optimization without arranging the task list in a way to achieve individual and business productivity.

A need exists for an effective method and computer system to automatically prioritize individual task lists to enable efficiency and achieve customization.

### SUMMARY OF THE INVENTION

Principal aspects of the present invention are to provide a method and computer system for implementing individual customized task prioritization based on real-time context. Other important aspects of the present invention are to provide such method, and computer system substantially without negative effects and that overcome some of the disadvantages of prior art arrangements.

In brief, a method and computer system are provided for implementing individual customized task prioritization based on real-time context of a user. A list of a plurality of tasks to be completed by a user based on a criteria is received. The list of a plurality of tasks is analyzed to determine ordering of the list of the plurality of tasks. A user's context is determined from user information received from predefined sensors, and prioritization of the list of the plurality of tasks is determined. The ordering of the plurality of tasks is identified by applying the current user's context and the criteria and the ordering identifies a current task to start.

In accordance with features of the invention, a concurrent task to start is identified with the current task.

In accordance with features of the invention, information about the user is received from an Internet of Things (IoT).

In accordance with features of the invention, a prerequisite task, which is not originally in list for a given task, is identified and generated, and prerequisite task is inserted Tx before the first task in the list of tasks.

In accordance with features of the invention, a user interface is provided allowing a user to add and position a new task into an existing list. Responsive to the user utilizing the user interface by entering the new task, automatically adjusting the ordering of the list, and rearranging if necessary.

In accordance with features of the invention, a user diagnostic command is provided, to enhance accuracy of the method.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1A is a block diagram of an example computer system for implementing individual customized task prioritization based on real-time context of a user in accordance with a preferred embodiment;

FIG. 1B is a flow chart of an example operational steps for implementing individual customized task prioritization based on real-time context of a user in accordance with a preferred embodiment;

FIGS. 2A and 2B illustrate an example method for implementing individual customized task prioritization based on real-time context of a user in accordance with a preferred embodiment;

FIGS. 3A and 3B illustrate example operational steps for implementing individual customized task prioritization based on real-time context of a user in accordance with a preferred embodiment; and

FIG. 4 is a block diagram illustrating a computer program product in accordance with the preferred embodiment.

### DETAILED DESCRIPTION OF THE PREFERRED EMBODIMENTS

In the following detailed description of embodiments of the invention, reference is made to the accompanying drawings, which illustrate example embodiments by which the invention may be practiced. It is to be understood that other embodiments may be utilized, and structural changes may be made without departing from the scope of the invention.

The terminology used herein is for the purpose of describing embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In accordance with features of the invention, a method and computer system are provided for implementing individual customized task prioritization based on real-time context of a user in accordance with a preferred embodiment.

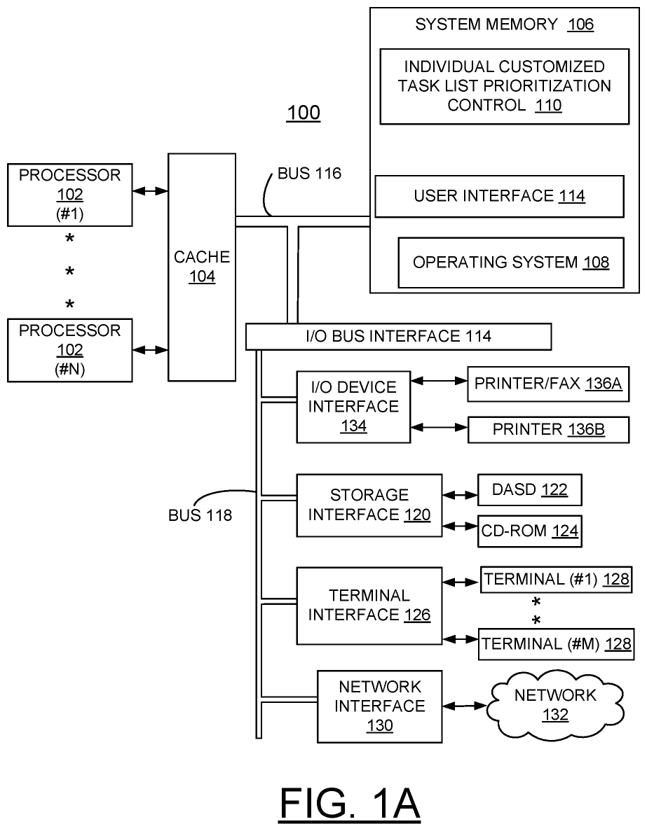

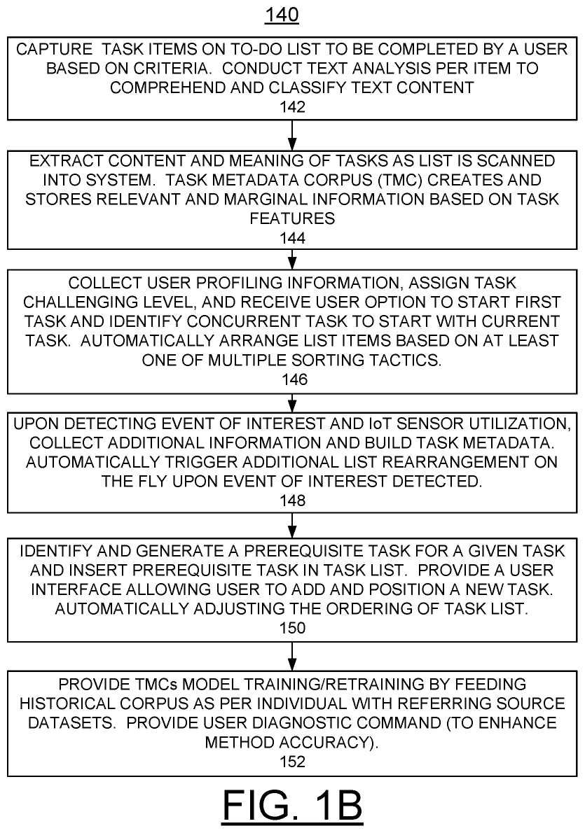

Having reference now to the drawings, in FIG. 1A, there is shown an example computer system generally designated by the reference character 100 for implementing individual customized task prioritization based on real-time context of a user in accordance with preferred embodiments. Computer system 100 includes one or more processors 102 or general-purpose programmable central processing units (CPUs) 102, #1-N. As shown, computer system 100 includes multiple processors 102 typical of a relatively large system; however, system 100 can include a single CPU 102. Computer system 100 includes a cache memory 104 connected to each processor 102.

Computer system 100 includes a system memory 106, an operating system 108, an individual customized task list prioritization control 110 in accordance with an embodiment of the invention and a user interface 112. System memory 106 is a random-access semiconductor memory for storing data, including programs. System memory 106 is comprised of, for example, a dynamic random access memory (DRAM), a synchronous direct random access memory (SDRAM), a current double data rate (DDRx) SDRAM, non-volatile memory, optical storage, and other storage devices.

I/O bus interface 114, and buses 116, 118 provide communication paths among the various system components. Bus 116 is a processor/memory bus, often referred to as front-side bus, providing a data communication path for transferring data among CPUs 102 and caches 104, system memory 106 and I/O bus interface unit 114. I/O bus interface 114 is further coupled to system I/O bus 118 for transferring data to and from various I/O units.

As shown, computer system 100 includes a storage interface 120 coupled to storage devices, such as, a direct access storage device (DASD) 122, and a CD-ROM 124. Computer system 100 includes a terminal interface 126 coupled to a plurality of terminals 128, #1-M, a network interface 130 coupled to a network 132, such as the Internet, local area or other networks, and a I/O device interface 134 coupled to I/O devices, such as a first printer/fax 136A, and a second printer 136B.

I/O bus interface 114 communicates with multiple I/O interface units 120, 126, 130, and 134, which are also known as I/O processors (IOPs) or I/O adapters (IOAs), through system I/O bus 116. System I/O bus 116 is, for example, an industry standard PCI bus, or other appropriate bus technology.

Computer system 100 is shown in simplified form sufficient for understanding the present invention. The present invention is not limited to the illustrated arrangement of computer system 100. Computer system 100 may be implemented with various commercially available systems.

Referring now to FIG. 1B, there shown is a flow chart of example operational steps generally designated by the reference character 140 for implementing individual customized task prioritization based on real-time context of a user in accordance with a preferred embodiment. As indicated at a block 142, task items on a to-do list to be completed by a user are captured based on a criteria. Text analysis per item to comprehend and classify text content is conducted at block 142. Content and meaning of tasks are extracted as the list is scanned into the system and task metadata corpus (TMC) creates and stores relevant and marginal information based on task features as indicated at a block 144. TMC is populated on the list level where each task item has its own metadata record.

User profiling information including for example medical condition is collected as supplemental resource when assigning a task challenging level, such as (0-9), and user is provided option to start challenging or non-challenging task first as indicated at a block 146. Note that the task challenging level at block 146 is not only individually specific, such as health condition, age and mobility, the task challenging level also responds to instant state change, for a continuous rainstorm would significantly level up the challenge of “grocery shopping” from 0 to 5, and further to 9 instantly if the user's car is broken. At block 146, list items are automatically arranged based on at least one of multiple sorting tactics, for example, task feature-based sorting in chronology order according to machine learning context analysis combining user profiling; prime selection sorting based upon detecting an event of interest; and correlation overlap sorting according to execution time and duration for identified correlated tasks to start in parallel.

As indicated at a block 148, upon detecting an event of interest and IoT sensor utilization, additional information is collected to build task metadata. Additional list rearrangement on the fly is automatically triggered upon event of interest detected at block 148. As indicated at a block 150, a new prerequisite task for a given task is identified and generated, and the prerequisite task is inserted in the task list. A user is provided with a user interface allowing the user to add and position a new task automatically adjusting the ordering of the task list at block 150. As indicated at a block 152, TMCs model training and retraining is provided by feeding historical corpus as per individual with referring source datasets. At block 152, a user diagnostic command is provided, for example, to enhance method accuracy.

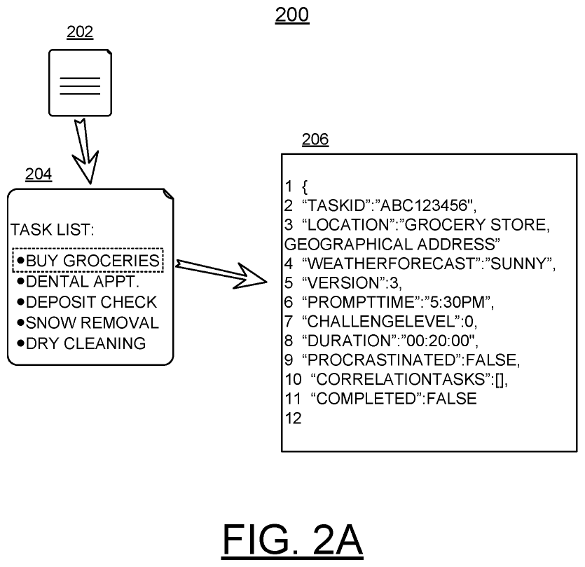

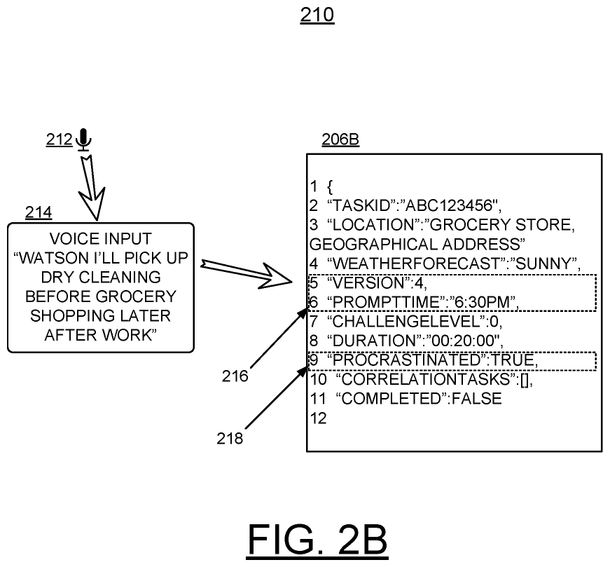

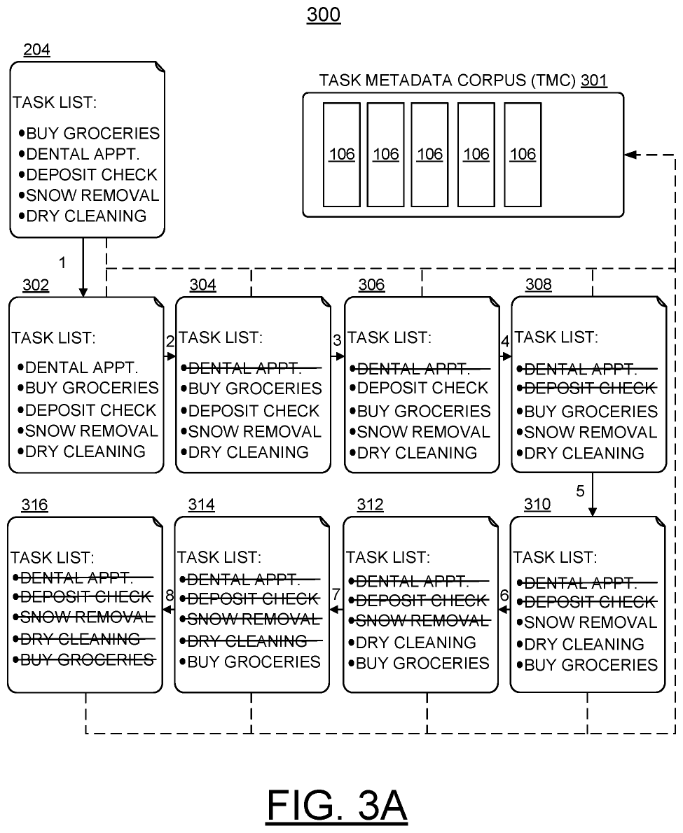

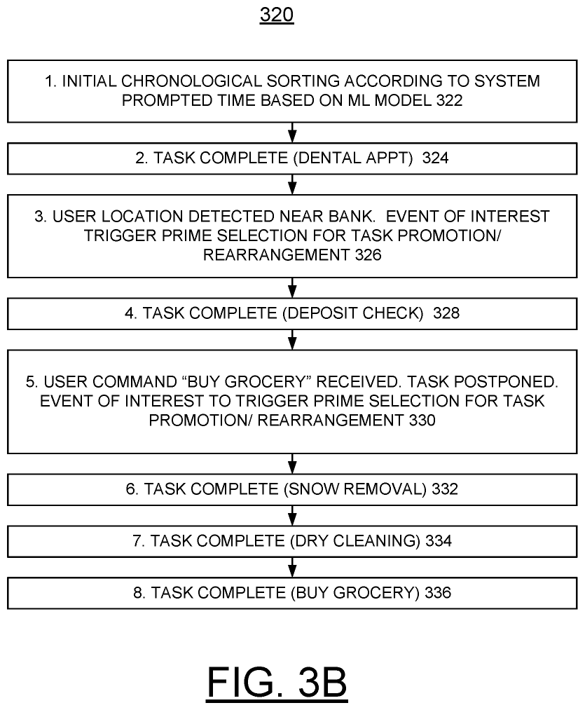

In accordance with features of the invention, the individual customized task list prioritization control 110, implements individual customized task prioritization based on real-time context of a user in accordance with a preferred embodiment, for example, as further shown in FIGS. 2A, and 2B and example operational steps, for example, as shown in FIGS. 3A, and 3B.

Referring now to FIGS. 2A and 2B, there is shown an example method for implementing individual customized task prioritization based on real-time context of the user in accordance with a preferred embodiment. In FIG. 2A, example system operations generally designated by the reference character 200 with task items received as indicated at 202. The task items 202 are captured on a task list 204, for example, buy groceries, dental appointment, deposit check, snow removal, and dry cleaning. Example task metadata corpus (TMC) 206 is illustrated for the item grocery list a task list 204. A separate TMC 206 creates and stores relevant and marginal information based on task features including the task challenging level. TMC 206 is populated on the list level where each list item has its own metadata record. When a new task is added to an existing list an additional metadata record associated to this task is added to the list corpus. When a task is complete, status of corresponding record is updated to completed and adjustment is made to the rest of the active records in corpus according as per correlation task. When the whole list is done, the corpus is archived. Relevant factors are defined in each task metadata.

In FIG. 2B, example operation operations generally designated by the reference character 210 with receiving a user input at a microphone 212, such as the voice input indicated at 214 of “Watson, I'll pick up dry cleaning before grocery shopping later after work.” The voice input 214 triggers event of resorting or list rearrangement as illustrated by updated metadata 206B including updated prompt time 216 and updated procrastinated True 218. Updated metadata 206B is done as per correlation task. The task metadata allows system tracking and modifying progress and prediction of the list with flexibility of referring and updating certain fields. Records in TMC are linked in a way that one or multiple sorting tactics are applied.

User voice input such as indicated at 214 are optionally allowed. User profiling and instant state are captured as miscellaneous factors. State change counts as event of interest only if it correlates with one of the tasks' metadata. When an event of interest is detected, it triggers list rearrangement, specifically, using prime selection. For example, when the user is at a location close to an associated task, the associated task is promoted to the top of the task list. Content of metadata is retrained in the system with respect to location, time, duration, challenge or difficulty level, and correlated tasks. TMC takes at least the following to achieve model retraining: historical corpus, active items, whether items are shorted or promoted properly. For example, existing art is applied to text training. Task features and metadata are captured and produced from the task list, and any additional items created by the same individual are added to existing and new corpus of metadata and retrained over time to create new learning model as each new list is created.

Referring now to FIGS. 3A and 3B illustrates example operational steps generally designated by the reference character 300 in FIG. 3A for implementing individual customized task prioritization based on real-time context in accordance with a preferred embodiment.

Example operational steps generally designated by the reference character 300 in FIG. 3A include an initial task list, such as task list 204 also shown in FIG. 2A. TMC 301 is generated as the initial task list is created in the system, and its content is update in the entire lifecycle if the task list is active. The Task list is considered active when there is at least one active task. Initial chronical sorting according to system prompted time based on machine learning model training as shown at block 302. A task is complete, such as dental appointment at block 304. A user location is detected at block 306, for example with a bank nearby. An event of interest to trigger prime selection for task promotion and rearrangement at block 306 moves task deposit check to the top of the task list with task buy groceries postponed. A task is complete, such as deposit check at block 308. At a block 310, the buy grocery task is postponed with task snow removal event of interest to trigger prime selection for task promotion and rearrangement. A task is complete, such as snow removal at block 312. A task is complete, such as dry cleaning at block 314. A task is complete, such as buy grocery at block 316.

In the flow chart of FIG. 3B, example operational steps generally designated by the reference character 320 include an initial chronological sorting according to system prompted time based on machine learning (ML) model as indicated at a block 322. As indicated at a block 324, a task complete, such as a dental appointment is identified. As indicated at a block 326, a user location is detected near bank, and an event of interest triggers prime selection for task promotion and rearrangement. As indicated at a block 328, a task complete, such as deposit check is identified. A user command buy grocery is received, and a task is postponed, and an event of interest triggers prime selection for task promotion and rearrangement. A task is complete, such as snow removal as indicated at a block 332. A task is complete, such as dry cleaning as indicated at a block 334. A task is complete, such as buy grocery as indicated at a block 336.

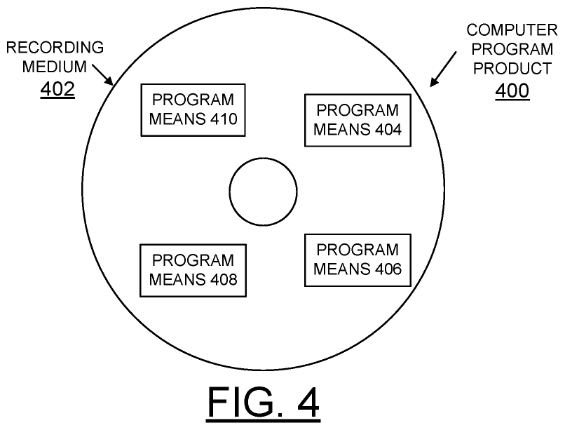

Referring now to FIG. 4, an article of manufacture or a computer program product 400 of the disclosure is illustrated. The computer program product 400 is tangibly embodied on a non-transitory computer readable storage medium that includes a recording medium 402, such as, a floppy disk, a high capacity read only memory in the form of an optically read compact disk or CD-ROM, a tape, or another similar computer program product. The computer readable storage medium 402, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Recording medium 402 stores program means or instructions 404, 404, 408, and 410 on the non-transitory computer readable storage medium 402 for carrying out the methods for implementing individual customized task prioritization based on real-time context in computer system 100 of FIG. 1A.

Computer readable program instructions 404, 404, 408, and 410 described herein can be downloaded to respective computing/processing devices from a computer readable storage medium or to an external computer or external storage device via a network, for example, the Internet, a local area network, a wide area network and/or a wireless network. The computer program product 400 may include cloud-based software residing as a cloud application, commonly referred to by the acronym (SaaS) Software as a Service. The network may comprise copper transmission cables, optical transmission fibers, wireless transmission, routers, firewalls, switches, gateway computers and/or edge servers. A network adapter card or network interface in each computing/processing device receives computer readable program instructions 404, 404, 408, and 410 from the network and forwards the computer readable program instructions for storage in a computer readable storage medium within the respective computing/processing device.

A sequence of program instructions or a logical assembly of one or more interrelated modules defined by the recorded program means 404, 404, 408, and 410, direct the system 100 for implementing individual customized task prioritization based on real-time context of the preferred embodiment.

While the present invention has been described with reference to the details of the embodiments of the invention shown in the drawing, these details are not intended to limit the scope of the invention as claimed in the appended claims.

What is claimed is:

1. A computer-implemented method for implementing individual customized task prioritization based on real-time context of the user, said computer-implemented method comprising:
receiving a list of a plurality of tasks to be completed by a user based on a criteria;
analyzing the list of the plurality of tasks to determine ordering of the plurality of tasks of the list including identified sequential tasks, concurrent tasks, and separate tasks;
determining a user's context from user information received from predefined sensors and determining prioritization of the plurality of tasks of the list; and
identifying the ordering of the plurality of tasks of the list by applying the current user's context and the criteria and identifying a current task to start from the ordering.

2. The computer-implemented method as recited in claim 1, includes identifying a concurrent task to start with the current task.

3. The computer-implemented method as recited in claim 1, wherein receiving a list of a plurality of tasks to be completed by a user based on a criteria includes extracting content and meaning of tasks as the list is scanned into a computer system.

4. The computer-implemented method as recited in claim 1, wherein receiving a list of a plurality of tasks to be completed by a user based on a criteria includes extracting a feature of each task, and providing task metadata corpus (TMC) to create and store predefined information based on task features.

5. The computer-implemented method as recited in claim 1, wherein determining a user's context from user information received from predefined sensors and determining prioritization of the plurality of tasks of the list includes collecting user profiling information including assigning task challenging level.

6. The computer-implemented method as recited in claim 1, wherein determining a user's context from user information received from predefined sensors and determining prioritization of the plurality of tasks of the list includes receiving user option to start first task, and identify concurrent task to start with current task.

7. The computer-implemented method as recited in claim 1, includes automatically arrange list items based on at least one of multiple sorting tactics.

8. The computer-implemented method as recited in claim 7, wherein the multiple sorting tactics include task feature-based sorting in chronology order according to machine learning context analysis combining user profiling.

9. The computer-implemented method as recited in claim 7, wherein the multiple sorting tactics include prime selection sorting based upon detecting an event of interest.

10. The computer-implemented method as recited in claim 7, wherein the multiple sorting tactics include correlation overlap sorting according to execution time and duration for identified correlated tasks to start in parallel.

11. A computer system for implementing individual customized task prioritization based on real-time context of the user comprising:
an individual customized task list prioritization control;
said individual customized task list prioritization control tangibly embodied in a non-transitory machine readable medium used to implement individual customized task prioritization based on real-time context;
said individual customized task list prioritization control, receiving a list of a plurality of tasks to be completed by a user based on a criteria;
said individual customized task list prioritization control, analyzing the list of the plurality of tasks to determine ordering of the plurality of tasks of the list including identified sequential tasks, concurrent tasks, and separate tasks;
said individual customized task list prioritization control, determining a user's context from user information received from predefined sensors and determining prioritization of the plurality of tasks of the list; and
said individual customized task list prioritization control, identifying the ordering of the plurality of tasks of the list by applying the current user's context and the criteria and identifying a current task to start from the ordering.

12. The computer system as recited in claim 12, wherein said processor uses said individual customized task list prioritization control code for implementing individual customized task prioritization based on real-time context.

13. The computer system as recited in claim 11, includes said individual customized task list prioritization control, identifying a concurrent task to start with the current task.

14. The computer system as recited in claim 11, includes said individual customized task list prioritization control, extracting a feature of each task, and providing task metadata corpus (TMC) to create and store predefined information based on task features.

15. The computer system as recited in claim 11, includes said individual customized task list prioritization control, detecting an event of interest and IoT sensor utilization, collecting and building task metadata and triggering list rearrangement on the fly.

16. The computer system as recited in claim 11, wherein said individual customized task list prioritization control, determining a user's context from user information received from predefined sensors and determining prioritization of the plurality of tasks of the list includes said individual customized task list prioritization control collecting user profiling information including assigning task challenging level.

17. The computer system as recited in claim 16, includes said individual customized task list prioritization control, receiving user option to a start first task, and identify concurrent task to start with the current task.

18. The computer system as recited in claim 11, includes said individual customized task list prioritization control, automatically arrange list items based on at least one of multiple sorting tactics.

19. The computer system as recited in claim 11, includes said individual customized task list prioritization control, automatically arranging list items based on a selected one of a chronology order task feature-based sorting according to machine learning context analysis combining user profiling; prime selection sorting based upon detecting an event of interest; and correlation overlap sorting according to execution time and duration for identified correlated tasks to start in parallel.

20. The computer system as recited in claim 11, includes said individual customized task list prioritization control, providing a user diagnostic command.
